(19) United States
(12) Patent Application Publication
(10) Pub. No.: US 2026/0364789 A1
(43) Pub. Date: Nov. 19, 2026

(54) PICKING ASSISTANCE METHOD AND PICKING ASSISTANCE DEVICE

(71) Applicant: PANASONIC INTELLECTUAL PROPERTY MANAGEMENT CO., LTD., Osaka (JP)

(72) Inventors: Kiyoshi SANO, Kanagawa (JP); Daiki MURAKAMI, Osaka (JP); Michitaka SAKON, Kanagawa (JP); Masanari MORISHITA, Osaka (JP)

(73) Assignee: PANASONIC INTELLECTUAL PROPERTY MANAGEMENT CO., LTD., Osaka (JP)

(21) Appl. No.: 19/546,997

(22) Filed: Feb. 23, 2026

(30) Foreign Application Priority Data
May 19, 2025 (JP) 2025-083559

(51) Int. Cl. B25J 9/16

(52) U.S. Cl. CPC B25J 9/163

(57) ABSTRACT

There is provided a picking assistance method including: calculating a similarity of each of one or more types of registered articles registered in a database, which holds gripping information including a past gripping result of a picking object by a picking robot, with respect to a new article whose gripping information is not held in the database, when an picking object is the new article; assigning at least a part of the gripping information of the registered article having a highest similarity among the calculated similarities as gripping information of the new article, and temporarily registering the new article in the database, when the highest similarity is equal to or higher than a predetermined first threshold value; and transmitting a picking instruction of the new article to the picking robot based on the gripping information assigned to the new article.

### CROSS-REFERENCE TO RELATED APPLICATIONS

This application is based on and claims priority under 35 USC 119 from Japanese Patent Application No. 2025-083559 filed on May 19, 2025, the contents of which are incorporated herein by reference.

### TECHNICAL FIELD

The present disclosure relates to a picking assistance method and a picking assistance device.

### BACKGROUND ART

WO2019/130429A1 discloses a picking system including a hypothesis region unit, a hypothesis gripping unit, a verification unit, and a picking object related information registration database. The hypothesis region unit hypothesizes a region of a picking object based on three-dimensional point cloud information and two-dimensional image generated by a camera. The hypothesis gripping unit assumes the picking object based on the region of the hypothesized picking object, and hypothesizes a gripping position and a gripping method of the assumed picking object. The verification unit verifies the hypothesized gripping position and gripping method using a robot. The picking object related information registration database registers a gripping position and a gripping method at which the picking object is successfully gripped as a result of the verification by the verification unit.

### SUMMARY OF INVENTION

The present disclosure provides a technique to easily realize picking even for a picking object with no prior picking records by using existing picking information.

According to an illustrative aspect of the present disclosure, a picking assistance method includes: calculating a similarity of each of one or more types of registered articles registered in a database, which holds gripping information including a past gripping result of a picking object by a picking robot, with respect to a new article whose gripping information is not held in the database, when an picking object is the new article; assigning at least a part of the gripping information of the registered article having a highest similarity among the calculated similarities as gripping information of the new article, and temporarily registering the new article in the database, when the highest similarity is equal to or higher than a predetermined first threshold value; and transmitting a picking instruction of the new article to the picking robot based on the gripping information assigned to the new article.

According to another illustrative aspect of the present disclosure, a picking assistance device includes: a processing device. The picking assistance device is configured to perform data communication with each of a picking robot that picks a picking object and a database that holds gripping information including a past gripping result of the picking object by the picking robot. The processing device is configured to: calculate a similarity of each of one or more types of registered articles registered in the database with respect to a new article whose gripping information is not held in the database, when the picking object is the new article; assign at least a part of the gripping information of the registered article having a highest similarity among the calculated similarities as gripping information of the new article, and temporarily register the new article in the database, when the highest similarity is equal to or higher than a predetermined first threshold value; and transmit a picking instruction of the new article to the picking robot based on the gripping information assigned to the new article.

Any combination of the above components, and conversion of an expression of the present disclosure between a method, a device, a system, a storage medium, a computer program, and the like are also effective in an aspect of the present disclosure.

According to the present disclosure, it is possible to easily realize picking even for a picking object with no prior picking records by using existing picking information.

### BRIEF DESCRIPTION OF DRAWINGS

FIG. 1 is a block diagram illustrating an overview of a warehouse system according to an embodiment;

FIG. 2 is a block diagram illustrating a hardware configuration example of an information processing device according to the present embodiment;

FIG. 3 is a schematic diagram illustrating a configuration example in a warehouse according to the present embodiment;

FIG. 4 is a table illustrating information held in an article database according to the present embodiment;

FIG. 5 is a schematic diagram illustrating a gripping success probability map according to the present embodiment;

FIG. 6 is a table illustrating an example of the article database according to the present embodiment;

FIG. 7 is a schematic diagram illustrating a similarity of a registered article to a new article according to the present embodiment;

FIG. 8 is a flowchart illustrating article database registration and update processing of a picking assistance device according to the present embodiment; and

FIG. 9 is a flowchart illustrating gripping position estimation processing of the picking assistance device according to the present embodiment.

### DESCRIPTION OF EMBODIMENTS

### Background to Present Disclosure

It is required to specify a gripping position of a picking object by a picking robot when picking the picking object. As a method of specifying the gripping position of the picking object, for example, a learning-based method of specifying the gripping position using a model trained based on training data prepared in advance, a rule-based method of specifying the gripping position based on a preset rule, or the like is considered. However, in the learning-based method, for example, a work for preparing a large amount of training data may be enormous. In addition, the rule-based method may have low versatility, and for example, it may be necessary to create a rule in accordance with each physical distribution warehouse that manages the picking object.

The picking system of WO2019/130429A1 registers verification results of the hypothesized gripping position and gripping method in a database. Then, at the time of actual operation, an accurate gripping position and gripping method are used as master data. When such a database that can be referred to for specifying the gripping position is created for, for example, a new customer, that is, a physical distribution warehouse or the like into which the picking robot has not been introduced, cost and time cost may increase. This is because various works such as capturing images of all the handled articles and movement of stored articles occur. The high barrier to entry for creating the database for specifying the gripping position can make it difficult for a new customer like those described above to even consider introducing the picking robot.

Even for an existing customer, that is, a physical distribution warehouse or the like into which a picking robot has been introduced, registering an article after a minor change in a database for specifying a gripping position every time a minor change such as a package change or an internal volume change of an article to be handled occurs may increase cost and time cost. Therefore, even when the picking object is an article with no prior picking records, it is required to easily estimate the gripping position of the picking object by the picking robot with high reliability.

Therefore, in the following embodiment, a technique for easily realizing estimation of a gripping position with high reliability even for a picking object with few picking records will be described.

Hereinafter, an embodiment specifically disclosing a picking assistance device and a picking assistance method according to the present disclosure will be described in detail with reference to the drawings as appropriate. However, unnecessarily detailed description may be omitted. For example, detailed description of well-known matters and redundant description of substantially the same configuration may be omitted. This is to avoid unnecessary redundancy of the following description and to facilitate understanding of a person skilled in the art. The accompanying drawings and the following description are provided for a person skilled in the art to fully understand the present disclosure, and are not intended to limit the subject matter described in the claims. Further, in the present specification, terms “first” and “second” are used merely to distinguish components and the like for convenience of description, and are not intended to be interpreted as being limited to specific components and the like.

### System Configuration

In a warehouse in which works such as receiving, storing, packing, and shipping of goods is performed, automation using a robot or the like is required in order to reduce a manual work load. With the increase in the number of goods in recent years, further improvement in efficiency of a series of works is required. In such a warehouse, since articles having various shapes and attributes are handled, it is necessary for people or robots to share works in consideration of characteristics of the articles. An example of such work is a picking work from an accommodation box (hereinafter referred to as a “storage bin”) in which articles are stored in a warehouse to an accommodation box (hereinafter referred to as a “shipping bin”) that accommodates one or more products to be shipped. The picking work is usually performed at a place called a picking station, and in this case, the storage bin and the shipping bin are arranged around the picking station, and a work subject moves the corresponding product from the storage bin to the shipping bin at the picking station. In the following description, not only one type of product but also a plurality of different types of products may be accommodated in the shipping bin. In addition, in the present specification, the article includes a product and the goods, and these terms may be replaced with each other.

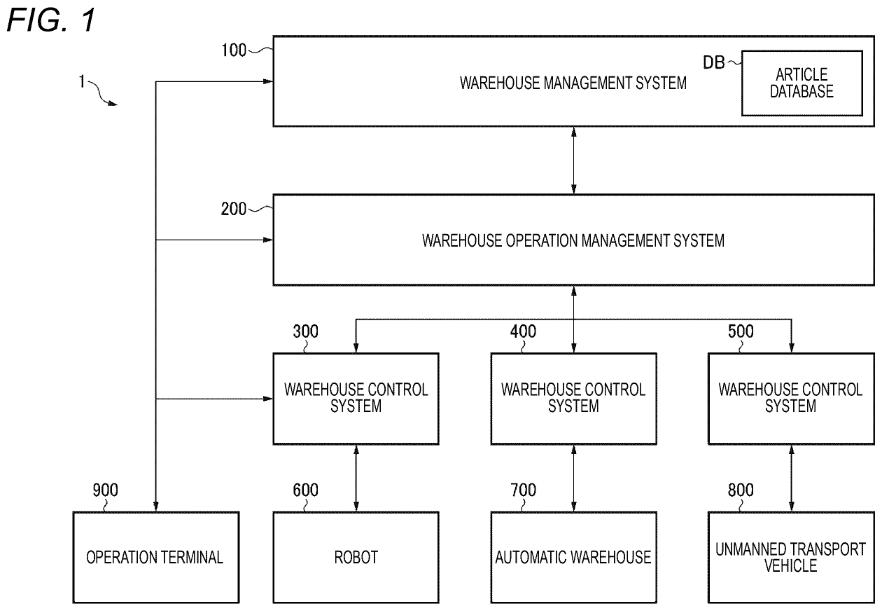

First, a configuration example of a warehouse system 1 according to the present embodiment will be described with reference to FIG. 1. FIG. 1 is a block diagram illustrating an overview of the warehouse system 1 according to the present embodiment. A system configuration illustrated in FIG. 1 is an example, and one system may be divided into a plurality of parts, or a plurality of systems may be integrated into one. In addition, a plurality of systems or devices illustrated in FIG. 1 may be provided. Furthermore, a processing subject described below is an example, and some of functions of a certain system may be realized as functions of another system.

The warehouse system 1 includes a warehouse management system 100, a warehouse operation management system 200, warehouse control systems 300, 400, and 500, a robot 600, an automatic warehouse 700, an automated transport vehicle 800, and an operation terminal 900. The components constituting the warehouse system 1 are configured to communicate with each other via a network. In the following description, it is assumed that the robot 600 is a picking robot that performs a picking work.

The warehouse management system 100 is a system that manages and controls logistics in the warehouse, and is positioned at the highest level in the configuration example illustrated in FIG. 1. The warehouse management system 100 manages, for example, inventory management of articles in the warehouse, and entry and exit (for example, receiving and shipment) and movement of articles. The warehouse management system may be referred to as a warehouse management system (WMS). The warehouse management system 100 is configured to be able to communicate with a further external system, which is not illustrated in FIG. 1, and may acquire and manage an instruction related to receipt and shipment of the articles, article information, information on a facility in a warehouse such as a robot, information on a worker, and the like.

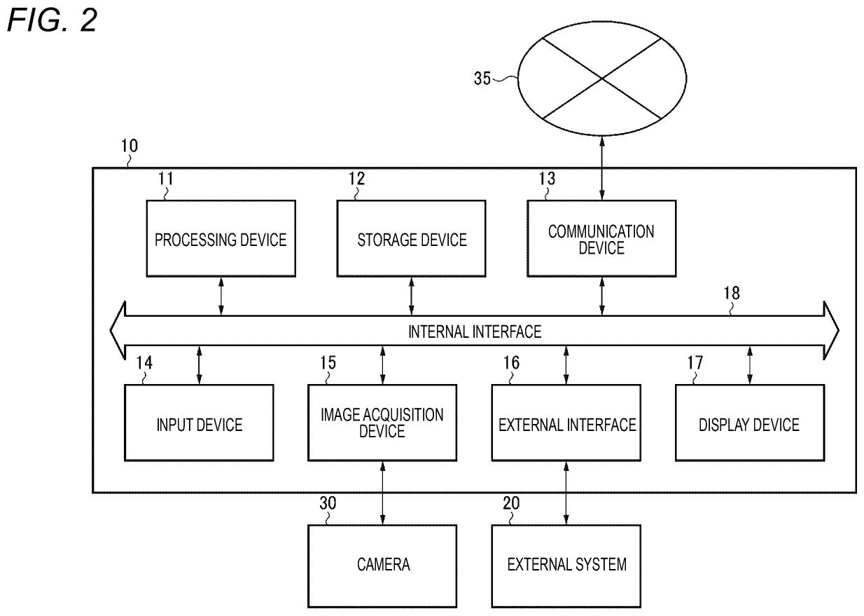

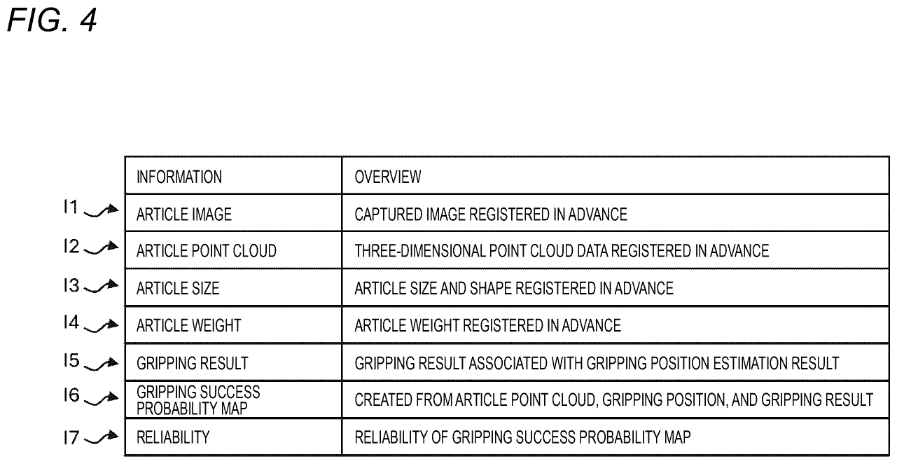

The warehouse management system 100 may include an article database DB that manages the article information and gripping information including a past gripping result of the picking object by the robot 600. The article database DB will be described later with reference to FIGS. 4, 5, and 6. The article database DB may be stored and held in, for example, a storage device (for example, see a storage device 12 in FIG. 2) of the warehouse management system 100. The article database DB may be accessible by other systems (specifically, the warehouse operation management system 200 and the warehouse control systems 300, 400, and 500) that can communicate with the warehouse management system 100. Furthermore, the article database DB may be stored and held in a storage device (for example, see the storage device 12 in FIG. 2) of a system other than the warehouse management system 100, or may be managed by an external system (for example, an external system 20 in FIG. 2) so as to be accessible by each system of the warehouse system 1.

The warehouse operation management system 200 is a system that manages and controls the work in the warehouse, and is positioned at a lower level of the warehouse management system 100 in the configuration example illustrated in FIG. 1. The warehouse operation management system 200 may be referred to as a warehouse execution system (hereinafter referred to as “WES”). The warehouse operation management system 200 performs comprehensive control of work contents of various work subjects in the warehouse and facilities in the warehouse.

The warehouse control systems 300, 400, 500 are provided corresponding to various facilities in the warehouse, respectively, and manage and control them. The warehouse control system may be referred to as a warehouse control system (hereinafter referred to as “WCS”). In the configuration example illustrated in FIG. 1, the warehouse control systems 300, 400, and 500 manage and control the robot 600, the automatic warehouse 700, and the automated transport vehicle 800, respectively. Hereinafter, the warehouse control system 300 may be referred to as a picking assistance device.

In the present embodiment, the picking assistance device (the warehouse control system 300) estimates the gripping position of the article to be picked by the robot 600 based on the information included in the article database DB. The picking assistance device updates the information included in the article database DB based on a picking result by the robot 600, in other words, a gripping result. The details will be described later.

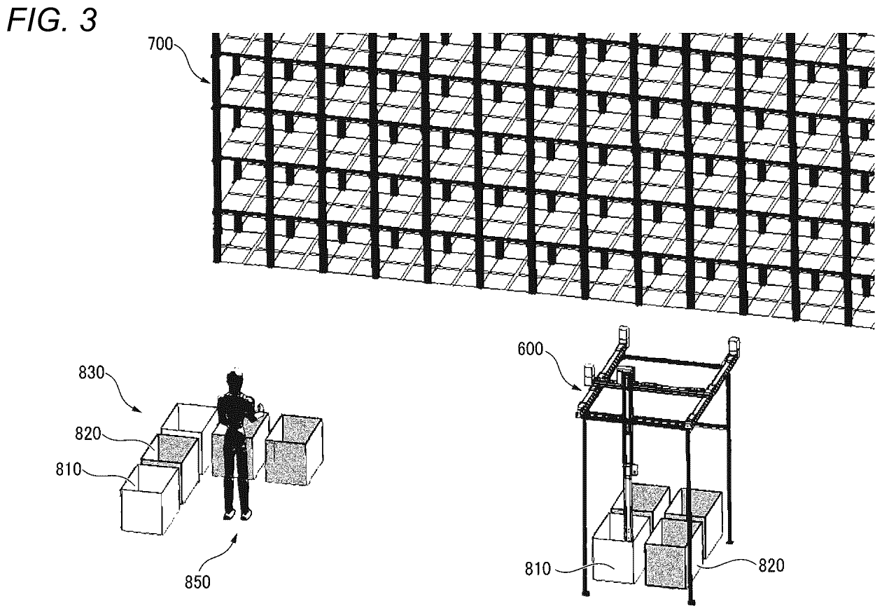

The robot 600 includes, for example, an orthogonal mechanism and a multi-axis arm, and is configured to hold an article accommodated in the storage bin at a tip portion of the arm. A configuration of the tip portion of the robot 600 may be, for example, a suction type or a gripping type by a multi-finger hand, and is not particularly limited. The robot 600 is designed for picking works on various articles, and a plurality of types of the robots 600 may be installed in the warehouse. For example, the robot 600 is disposed in the picking station (see FIG. 3) provided in the warehouse. In addition, a camera for capturing a peripheral image, particularly, an image of a bin arranged in the periphery may be installed around the robot 600. Hereinafter, the gripping of the article by the robot 600 means that the robot 600 holds the article regardless of whether the configuration of the tip portion of the robot 600 is, for example, a suction type or a gripping type by a multi-finger hand.

The automatic warehouse 700 is configured to accommodate one or more storage bins capable of accommodating the articles, and transports the storage bin to a target position using the automated transport vehicle 800 in response to a request from the warehouse operation management system 200. The transport of the storage bin is not limited to the use of the automated transport vehicle 800. For example, the storage bin may be transported using a belt conveyor or the like. The automatic warehouse 700 includes, for example, a lattice-shaped frame so as to accommodate a plurality of storage bins. The storage bin may include not only a storage bin in which an article is accommodated but also an empty storage bin in which no article is accommodated and a storage bin in which an article to be accommodated is not determined. The bins used in the automatic warehouse 700 may include not only the storage bins described above but also the shipping bins that collectively accommodate products at the time of shipping from the warehouse in accordance with order information. Although the shapes and dimensions of the storage bin and the shipping bin may be different from each other, the storage bin and the shipping bin are configured to be transportable by the automated transport vehicle 800, and in the following description, the storage bin and the shipping bin have the same configuration as a rectangular box.

The automated transport vehicle 800 is a vehicle for transporting a bin (for example, the storage bin or the shipping bin) to a predetermined position in the automatic warehouse 700 designated by the warehouse operation management system 200, and automatically moves or waits by a frame (see the above description) constituting the automatic warehouse 700 based on an instruction from the warehouse operation management system 200. The automated transport vehicle 800 may be referred to as, for example, an automatic guided vehicle (hereinafter, referred to as “AGV”). The automated transport vehicle 800 may be configured such that a bin is detachably mounted on an upper portion thereof, or may be configured to transport the bin by pushing or pulling the bin. The automated transport vehicle 800 includes, for example, a traveling unit for performing an operation related to movement, a sensor for acquiring peripheral information, a communication unit for transmitting and receiving data to and from the warehouse control system 500, and the like.

The operation terminal 900 is an information processing device configured to be usable by a worker (person) inside and outside the warehouse. The operation terminal 900 may be, for example, a stationary information processing device such as a personal computer (hereinafter referred to as a “PC”), or may be a mobile terminal such as a tablet terminal, a point of sales (hereinafter referred to as a “POS”) terminal, a handheld terminal, or a smartphone. The operation terminal 900 transmits and receives data to and from the warehouse management system 100, the warehouse operation management system 200, and the warehouse control systems 300, 400, and 500, receives a notification from each system, and is used when setting and operating each system.

### Hardware Configuration Example

Next, a hardware configuration example of the information processing device 10 constituting the warehouse system 1 according to the present embodiment will be described with reference to FIG. 2. FIG. 2 is a diagram illustrating an example of a hardware configuration of the information processing device 10 according to the present embodiment. The information processing device 10 of FIG. 2 can be applied as a configuration of each system (specifically, the warehouse management system 100, the warehouse operation management system 200, and the warehouse control systems 300, 400, and 500) illustrated in FIG. 1. Each system illustrated in FIG. 1 may be configured as an on-premise server device at a base where a warehouse is positioned, or may be configured as a cloud system on a network. Here, the configuration of the devices constituting the respective system will be described as the same, but some portions may be omitted or other portions may be added in accordance with the provided function. Examples of the added portion include a barcode reader used to acquire information from a barcode attached to the article or the bin in the warehouse.

The information processing device 10 includes a processing device 11, the storage device 12, a communication device 13, an input device 14, an image acquisition device 15, an external interface 16, and a display device 17. These portions are communicable with each other via an internal interface 18.

The processing device 11 may be configured using, for example, a central processing unit (hereinafter, referred to as “CPU”), a graphical processing unit (hereinafter, referred to as “GPU”), a micro processing unit (hereinafter, referred to as “MPU”), a digital signal processor (hereinafter, referred to as “DSP”), or a field-programmable gate array (hereinafter, referred to as “FPGA”). The processing device 11 achieves various functions to be described later, for example, by referring to various data stored in the storage device 12 or reading out programs.

The storage device 12 is a storage unit for storing various data, programs, and the like, and may include volatile/non-volatile storage devices such as a random access memory (hereinafter, referred to as “RAM”), a read only memory (hereinafter, referred to as “ROM”), a hard disk drive (hereinafter, referred to as “HDD”), and a solid state drive (hereinafter, referred to as “SSD”).

The communication device 13 is an interface for communicating with an external device via a network 35. A communication standard available to the communication device 13 is not particularly limited, and may be wired/wireless. Further, a plurality of communication standards may be available. Therefore, the network 35 may be implemented by combining networks using the plurality of communication standards.

The input device 14 receives an operation or an instruction by a user (for example, an administrator or a worker) of the warehouse. The input device 14 may implemented by a mouse, a keyboard, a touch panel display, or the like.

The image acquisition device 15 is an interface for acquiring captured images in the warehouse captured by cameras 30 disposed at various positions in the warehouse, or captured images of the storage bin, the shipping bin, the article, or the like captured by the camera 30 installed in the robot disposed at the picking station or the like.

The external interface 16 is an interface for communicating with the external system 20. The information processing device 10 may be communicably connected to the external system 20 via the communication device 13 and the network 35. The external system 20 is not limited to each system illustrated in FIG. 1 (that is, the warehouse management system 100, the warehouse operation management system 200, and the warehouse control systems 300, 400, and 500), and may be another system.

The display device 17 mainly displays various user interfaces generated by the processing device 11 to the user. The display device 17 may implemented by a liquid crystal display, a touch panel display, a lamp, or the like.

### Overview of Warehouse

Next, an overview of a warehouse to which the warehouse system 1 according to the present embodiment is introduced will be described with reference to FIG. 3. FIG. 3 is a conceptual diagram illustrating a configuration example in the warehouse of the warehouse system 1 according to the present embodiment. In the warehouse, the automatic warehouse 700 and one or more robots 600 are installed. Although not illustrated in FIG. 3, a plurality of automated transport vehicles 800 that transport a bin such as the storage bin to the position of a worker 850 or the robot 600 are disposed in the warehouse or the automatic warehouse 700 so as to be able to travel.

A picking station 830 where the worker 850 as a work subject of the picking work performs a work is provided around the automatic warehouse 700. A picking station where the robot 600 performs a work is also provided. In the picking station, the work subject (specifically, the robot 600 or the worker 850) performs a work of transferring an article from the storage bin 810 to the shipping bin 820 (that is, the picking work). In addition, from the viewpoint of efficiency of the entire shipping work, when it is desirable to temporarily wait around the picking station instead of moving the bin into the automatic warehouse 700, a waiting area for waiting the bin may be provided.

In the example of FIG. 3, an example is illustrated in which one picking station where the worker 850 who is a person works and one picking station where the robot 600 works are provided, but the present disclosure is not limited thereto. In the warehouse, a plurality of areas of the picking stations may be provided. Alternatively, only one of the picking station where the person works and the picking station where the robot works may be provided. Although an example is illustrated in which the robot 600 including the orthogonal mechanism is installed as the robot 600, a robot including a multi-axis arm may be installed.

### Article Database

Next, an overview and a specific example of information held in the article database DB will be described with reference to FIGS. 4, 5, and 6. FIG. 4 is a table illustrating the information held in the article database DB according to the present embodiment.

The article database DB includes the article information and the gripping information. The article information includes information I1, I2, I3, and I4, and the gripping information includes information I5, I6, and I7.

The information I1 is an article image and is a captured image of an article managed in the automatic warehouse 700. The captured image of the article may be captured by the camera 30. The information I2 is an article point cloud and is three-dimensional point cloud data of the article. The information I3 is an article size and indicates the size and shape of the article. The information I4 is an article weight and indicates weight of the article. These pieces of article information are registered in advance when managed in the automatic warehouse 700. On the other hand, the gripping information to be described later may be updated by picking the articles managed in the automatic warehouse 700.

The information I5 is a gripping result and is a result of picking (that is, gripping) of an article by the robot 600. The gripping result is stored in association with an estimation result of the gripping position. The estimation result of the gripping position is the gripping position of the article by the robot 600 estimated by the picking assistance device. Briefly speaking, the estimation result of the gripping position indicates which part of the article should be gripped. The gripping result is associated with the estimation result of the gripping position. Therefore, the information I5 indicates whether the robot 600 has succeeded in gripping the article as a result of gripping the article based on the gripping position indicated by the estimation result of the gripping position. In the present embodiment, the position of the article gripped by the robot 600 is the gripping position indicated by the estimation result of the gripping position. For convenience of description, an actual gripping position when the robot 600 grips the article does not necessarily have to completely match the gripping position indicated by the estimation result of the gripping position. This is because an error may occur between the actual gripping position and the gripping position indicated by the estimation result of the gripping position when the robot 600 grips the article. A range of the error is not particularly limited.

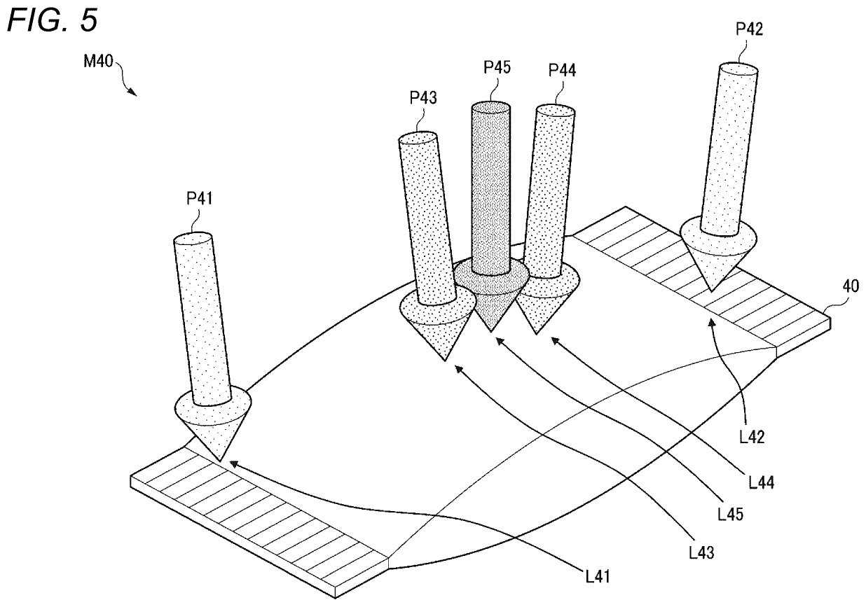

The information I6 is a gripping success probability map created from the article point cloud indicated by the information I2 and the gripping position and the gripping result indicated by the information I5. The gripping success probability map indicates a gripping success probability of the robot 600 at a predetermined gripping position of the article. A specific example will be described later with reference to FIG. 5.

The information I7 is reliability of the gripping success probability map indicated by the information I6. Although a flow of the processing of the picking assistance device will be described later again, the picking assistance device can determine that the estimation result of the gripping position of the article is reliable when the reliability of the gripping success probability map of the article is equal to or higher than a predetermined second threshold value. Then, the picking assistance device can estimate the gripping position of the article based on the gripping success probability map of the article. The predetermined second threshold value related to the reliability of the gripping success probability map may be set in advance by the user, for example.

FIG. 5 is a schematic diagram illustrating the gripping success probability map M40 according to the present embodiment. The gripping success probability map M40 indicates the probability of successful gripping depending on which part of the article 40 is gripped. In the example of FIG. 5, probabilities P41, P42, P43, P44, and P45 indicate success probabilities when the robot 600 grips the article 40 at positions L41, L42, L43, L44, and L45, respectively.

In the example of FIG. 5, a magnitude relationship between the probabilities P41, P42, P43, P44, and P45 is expressed by the following Formula (1).

P45>P43=P44>P41=P42 . . . (1)

Therefore, among the positions L41, L42, L43, L44, and L45, the robot 600 is most likely to be successful in gripping the article 40 at the position L45.

For the sake of explanation, five candidate gripping positions of the article 40 are given, but the gripping positions and the number of positions for gripping for which the success probability is indicated in the gripping success probability map are not limited thereto. In the example of FIG. 5, the success probability of gripping is indicated by an arrow, but this is merely an example for description. The gripping success probability map may include the gripping success probability of the robot 600 at the predetermined gripping position of the article as data.

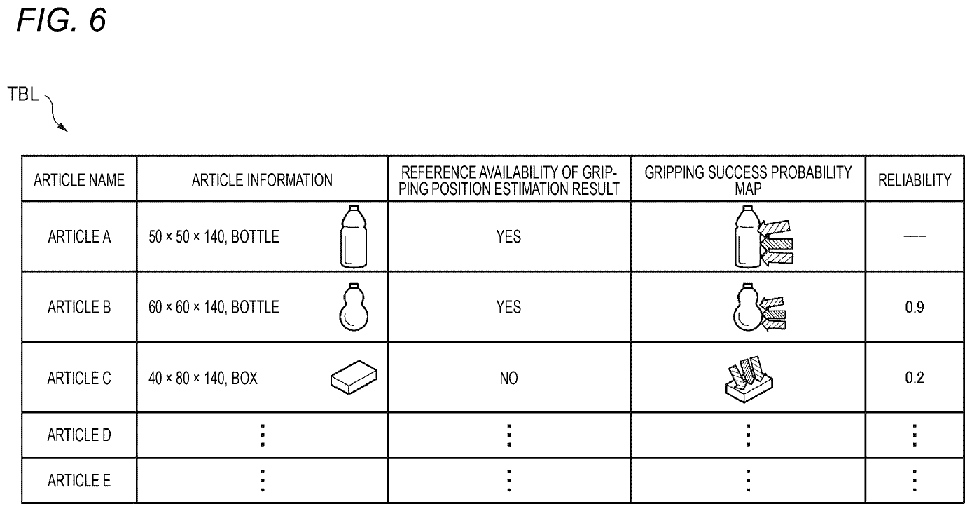

FIG. 6 is a table illustrating an example of the article database DB according to the present embodiment. A table TBL illustrating an example of the article database DB includes, as items, an article name, the article information, reference availability of the estimation result of the gripping position, the gripping success probability map, and the reliability. In the example of FIG. 6, it is assumed that the table TBL is generated by the picking assistance device and displayed on a display device (for example, see the display device 17 of FIG. 2) so as to be referred to by the user. Therefore, the items included in the table TBL may indicate the information I1, I2, I3, I4, I5, I6, and I7 and information generated from these pieces of information based on the setting of the user. However, the configuration example of the article database DB is not limited to the table TBL, and the article database DB can store and hold the information I1, I2, I3, I4, I5, I6, and I7 and information generated from these pieces of information. That is, the table TBL illustrates some of the various types of information illustrated in FIG. 4, but the article database DB may include the entire information.

In the example of FIG. 6, the item of the article information of an article A illustrates the width, depth, and height (50×50×140) of the article, the shape being a bottle, and an image of the article A. That is, the information I1 and the information I3 are illustrated in the item of the article information. As described above, the information I1 and I3 among the information I1, I2, I3, and I4 as the article information may be set by the user to be illustrated in the table TBL.

The table TBL indicates the reference availability of the estimation result of the gripping position of the article based on the information I7 (that is, the reliability of the gripping success probability map). The picking assistance device can determine that the estimation result of the gripping position of the article is reliable when the reliability of the gripping success probability map of the article is equal to or higher than the predetermined second threshold value. In this way, when it is determined that the estimation result of the gripping position of the article is reliable based on the reliability of the article, the item of the reference availability of the estimation result of the gripping position of the table TBL indicates that reference is available. On the other hand, when the reliability of the article is lower than the predetermined second threshold value, the item of the reference availability of the estimation result of the gripping position in the table TBL indicates that reference is unavailable. In the example of FIG. 6, the estimation result of the gripping position of each of the article A and the article B can be referred to, but the estimation result of the gripping position of the article C cannot be referred to.

The table TBL indicates the information I6 of each article, that is, the gripping success probability map. Further, the table TBL indicates the information I7 of each article, that is, the reliability of the gripping success probability map. In the example of FIG. 6, the reliability of the article B is 0.9, and the reliability of the article C is 0.2. In the present embodiment, the reliability is set by a number between 0 and 1, and the reliability increases as it approaches 1. The reliability may be indicated by a number, or may be indicated so that the reliability can be evaluated by a non-numerical indicator other than the number (for example, English letters). In the example of FIG. 6, the reliability of the article A is not illustrated. This is because the reliability of the article A becomes equal to or higher than a predetermined specified value by being updated. In the present embodiment, the predetermined specified value is 1, but the present disclosure is not limited thereto, and the predetermined specified value may be freely set by the user. Further, the predetermined specified value is larger than the predetermined second threshold value set for the reliability. The update of the reliability will be described later. Next, registration of an article in the article database DB performed by the picking assistance device will be described.

When the article to be picked is an article whose gripping information is not held in the article database DB, that is, a “new article”, the picking assistance device temporarily registers the new article in the article database DB as an “article under registration”. The picking assistance device updates the reliability of the article under registration temporarily registered in the article database DB, and registers the article under registration as a “registered article” when the updated reliability is equal to or higher than the predetermined specified value.

In the example of FIG. 6, in the article database DB, the article A is registered as the registered article, and the article B and the article C are temporarily registered as the articles under registration. The article D and the article E are new articles. Therefore, the picking assistance device temporarily registers the article D and the article E in the article database DB as the articles under registration.

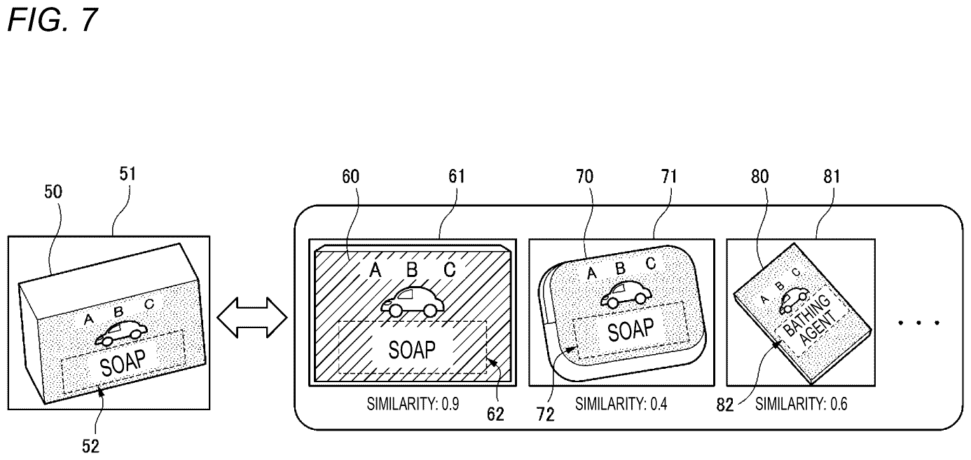

The picking assistance device compares each of the article D and the article E to be newly and temporarily registered in the article database DB with the registered article. For convenience of explanation, it is assumed that a plurality of registered articles are registered in addition to the article A. The picking assistance device calculates a similarity of each of the plurality of registered articles to the article D and a similarity of each of the plurality of registered articles to the article E. The similarity will be described later with reference to FIG. 7. The picking assistance device temporarily registers the article D in the article database DB using at least a part of the gripping information of the registered article having the highest similarity to the article D, that is, the registered article most similar to the article D, specifically, the gripping success probability map as the gripping information of the article D. At this time, when the highest similarity among the calculated similarities is equal to or higher than a predetermined first threshold value, the picking assistance device sets the value of the highest similarity as the reliability of the gripping success probability map of the article D. On the other hand, when the highest similarity among the calculated similarities is lower than the predetermined first threshold value, the picking assistance device sets a predetermined initial value smaller than the predetermined first threshold value as the reliability of the gripping success probability map of the article D. At this time, the picking assistance device does not assign the gripping information of the registered article to the article D. Since the article E is the same as the article D, the description thereof will be omitted. The predetermined first threshold value and the predetermined initial value may be freely set by the user.

It is desirable that the picking assistance device assigns the gripping information (the gripping success probability map) of the registered article having the highest similarity among the calculated similarities, and the estimation result of the gripping position of the new article temporarily registered in the article database DB as the article under registration can be referred to. The picking assistance device causes the robot 600 to perform picking based on the estimation result of the gripping position of the temporarily registered new article, that is, the gripping position estimated based on the gripping success probability map of the registered article similar to the new article, so that it is possible to easily realize picking with a high gripping success probability for the new article with no prior picking records. For example, the article B may be an article that has been assigned gripping information of a registered article and is temporarily registered in the article database DB. On the other hand, for example, the article C is not assigned the gripping information of the registered article, that is, there is no registered article similar to the article C (having a high similarity), and the reliability may be an article temporarily registered in the article database DB as an initial value.

### Similarity

FIG. 7 is a schematic diagram illustrating the similarity of the registered article to the new article according to the present embodiment. A case where a new article 50 is newly handled in the automatic warehouse 700 will be described as an example with reference to FIG. 7. In this case, in order to temporarily register the new article 50 in the article database DB, the picking assistance device calculates the similarity of each registered article to the new article 50 as follows.

First, the picking assistance device acquires a captured image 51 of the new article 50 captured by the camera 30. When an article is newly handled in the automatic warehouse 700, the camera 30 captures a captured image of the article.

For the sake of explanation, registered articles 60, 70, and 80 each are taken as an example of the registered article for which the similarity to the new article 50 is calculated.

The picking assistance device calculates the similarity of each of the registered articles 60, 70, and 80 to the new article 50 using the following Formula (2).

Similarity=a×S_{image}+b×S_{physical}+c×Sₜₑₓₜ . . . (2)

Here, each of S_{image}, S_{physical} and Sₜₑₓₜ in Formula (2) indicates a similarity of a feature of the captured image, a similarity of physical parameters indicating the size and the weight, and a similarity of text information included in the captured image. Each of a, b, and c is a weighting parameter and may be freely set by the user.

The feature of the captured image is a feature extracted from the captured image, and includes, for example, a shape of an article appearing in the captured image. Captured images 61, 71, and 81 of the registered articles 60, 70, and 80 are registered in the article database DB in advance.

The physical parameter may be determined by, for example, the information I3 and the information I4 registered in the article database DB in advance.

In the example of FIG. 7, the text information includes a text 52 described in the new article 50, a text 62 described in the registered article 60, a text 72 described in the registered article 70, a text 82 described in the registered article 80, and the like. The text information may be recognized and extracted from the captured image by a known technique (for example, an optical character recognition (hereinafter, referred to as “OCR”) technique).

In the example of FIG. 7, the similarities of the registered articles 60, 70, and 80 to the new article 50 are 0.9, 0.4, and 0.6, respectively. The picking assistance device assigns the gripping information of the registered article 60 having the highest similarity among the calculated similarities to the new article 50. However, the picking assistance device assigns the reliability of the gripping success probability map in the gripping information in accordance with the following conditions as described above. That is, when the highest similarity among the calculated similarities is equal to or higher than the predetermined first threshold value, the picking assistance device sets the value of the highest similarity as the reliability of the gripping success probability map of the new article 50. That is, when 0.9, which is the similarity of the registered article 60 to the new article 50, is equal to or higher than the predetermined first threshold value, the reliability of the gripping success probability map of the new article 50 is 0.9. On the other hand, when the highest similarity among the calculated similarities is lower than the predetermined first threshold value, the picking assistance device does not assign the gripping information of any registered article to the new article 50, and sets the predetermined initial value as the reliability of the gripping success probability map of the new article 50. That is, when 0.9, which is the similarity of the registered article 60 to the new article 50, is lower than the predetermined first threshold value, the reliability of the gripping success probability map of the new article 50 is the predetermined initial value. The predetermined initial value may be, for example, 0.

### Processing Flow

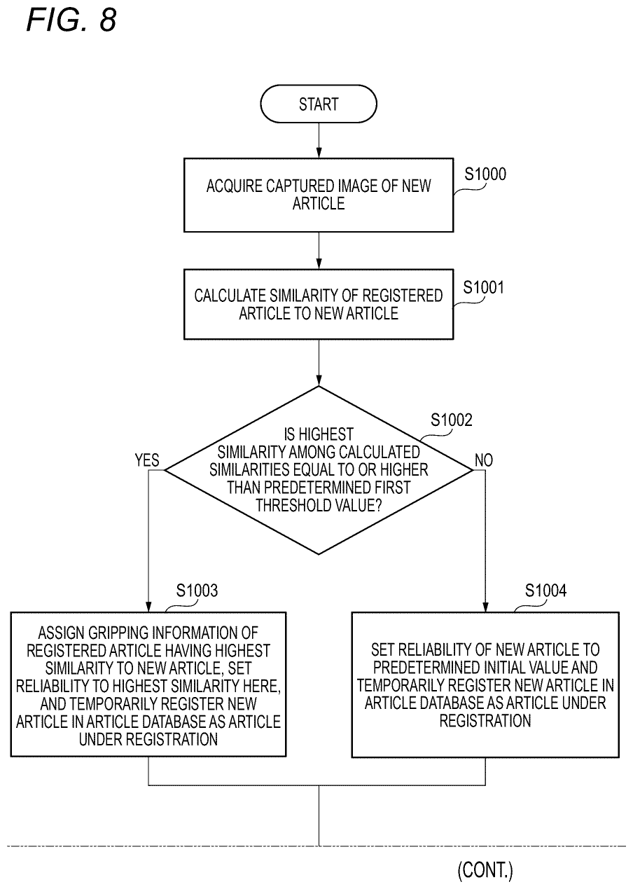

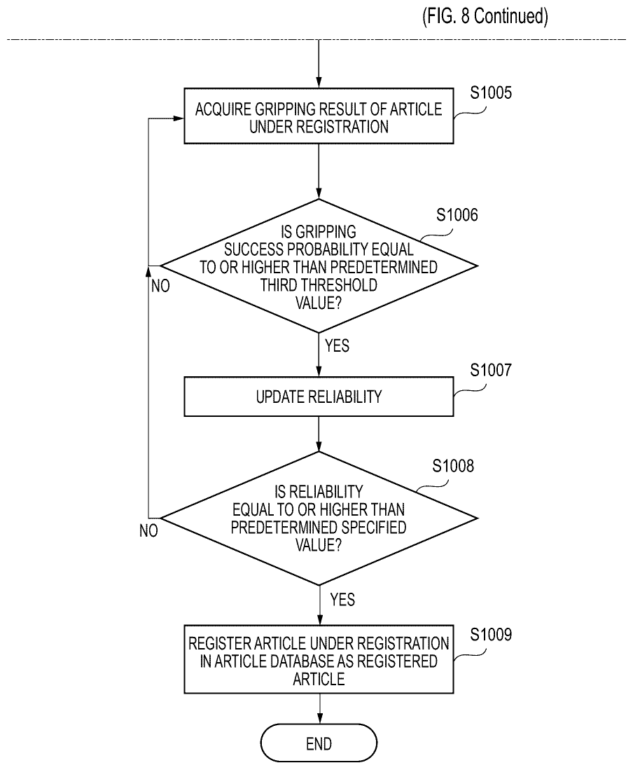

FIG. 8 is a flowchart illustrating article database registration and update processing of the picking assistance device according to the present embodiment. At the start of the flowchart, the image of a new article to be newly managed in the automatic warehouse 700 is captured by the camera 30.

The picking assistance device acquires a captured image of the new article (step S1000). Accordingly, the picking assistance device registers the information I1 of the new article in the article database DB. The picking assistance device may register not only the information I1 of the new article but also the information I2, I3, and I4 in the article database DB. Furthermore, it is assumed that a plurality of registered articles are registered in the article database DB.

The picking assistance device calculates the similarity of the registered article to the new article (step S1001). The picking assistance device can calculate the similarity based on the captured image of the new article acquired in step S1000 and the article information of the registered article and the new article registered in the article database DB.

The picking assistance device determines whether the highest similarity among the similarities calculated in step S1001 is equal to or higher than the predetermined first threshold value (step S1002).

When it is determined that the highest similarity among the similarities calculated in step S1001 is equal to or higher than the predetermined first threshold value (step S1002: YES), the picking assistance device proceeds the processing to step S1003. The picking assistance device assigns the gripping information of the registered article having the highest similarity among the calculated similarities to the new article, sets the reliability to the highest similarity here, and temporarily registers the new article in the article database DB as the article under registration (step S1003). Then, the picking assistance device proceeds the processing to step S1005.

When it is determined that the highest similarity among the similarities calculated in step S1001 is not equal to or higher than the predetermined first threshold value, that is, is lower than the predetermined first threshold value (step S1002: NO), the picking assistance device proceeds the processing to step S1004. The picking assistance device sets the reliability of the gripping success probability map of the new article to the predetermined initial value, and temporarily registers the new article in the article database DB as the article under registration (step S1004). Then, the picking assistance device proceeds the processing to step S1005.

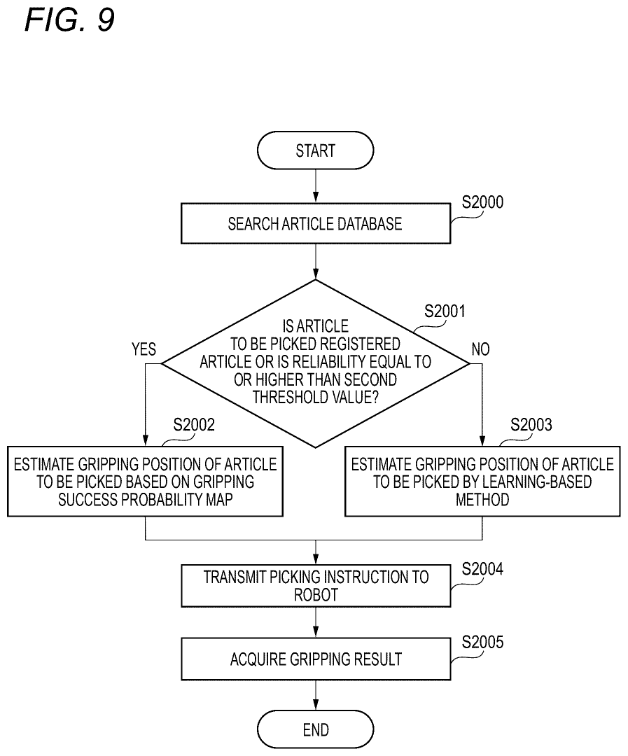

For convenience of description, it is assumed that picking (that is, gripping) of the article under registration temporarily registered in the article database DB in step S1003 or step S1004 by the robot 600 is performed (see FIG. 9). Further, in the present embodiment, the picking by the robot 600 is performed based on the gripping information, more accurately, the gripping position estimated based on the gripping success probability map in the gripping information, or the gripping position estimated by a learning-based method to be described later.

The picking assistance device acquires the gripping result of the article under registration temporarily registered in the article database DB in step S1003 or step S1004 (step S1005). The picking assistance device may acquire the gripping result from, for example, the robot 600 or may acquire the gripping result by analyzing the captured image acquired from the camera 30 provided in the picking station. The picking assistance device may acquire the gripping result each time picking is performed, or may collectively acquire a plurality of gripping results. For convenience of description, it is assumed that the picking assistance device acquires the plurality of gripping results of the article under registration.

The picking assistance device determines whether the gripping success probability of the article under registration is equal to or higher than a predetermined third threshold value based on the plurality of gripping results of the article under registration (step S1006). The predetermined third threshold value may be freely set by the user.

When it is determined that the gripping success probability of the article under registration is not equal to or higher than the predetermined third threshold value, that is, is lower than the predetermined third threshold value (step S1006: NO), the picking assistance device returns the processing to step S1005.

When it is determined that the gripping success probability of the article under registration is equal to or higher than the predetermined third threshold value (step S1006: YES), the picking assistance device updates the reliability of the gripping success probability map of the article under registration (step S1007). At this time, the picking assistance device increases the reliability by a preset value. For example, when the gripping success probability of the article under registration is 99% or higher, the picking assistance device may update the reliability of the gripping success probability map to increase by 0.1.

The picking assistance device determines whether the reliability updated in step S1007 is equal to or higher than the predetermined specified value (step S1008).

When it is determined that the reliability updated in step S1007 is not equal to or higher than the predetermined specified value, that is, is lower than the predetermined specified value (step S1008: NO), the picking assistance device returns the processing to step S1005.

When it is determined that the reliability updated in step S1007 is equal to or higher than the predetermined specified value (step S1008: YES), the picking assistance device registers the article under registration being temporarily registered in the article database DB as a registered article (step S1009). Then, the picking assistance device ends the processing flow.

In this way, the picking assistance device can assign the gripping information of the registered article whose gripping information is held in the article database DB to the new article whose gripping information is not held in the article database DB, and can temporarily register the new article in the article database DB as the article under registration. Accordingly, the picking assistance device can cause the robot 600 to pick the new article based on the existing gripping information of the registered article similar to the new article. Then, the picking assistance device can update the reliability of the gripping success probability map of the new article (the article under registration) based on the gripping result of the new article (the article under registration). Then, when the updated reliability is equal to or higher than the predetermined specified value, the picking assistance device can register the new article (the article under registration) in the article database DB as the registered article. The gripping information of the registered article registered in the article database DB in this way can be assigned as gripping information of another new article.

FIG. 9 is a flowchart illustrating gripping position estimation processing of the picking assistance device according to the present embodiment. At the start of this flowchart, it is assumed that the picking assistance device (the warehouse control system 300) has received a picking instruction for the article to be picked from, for example, the warehouse operation management system 200.

The picking assistance device searches the article database DB for the article to be picked (step S2000). Here, it is assumed that information on the article to be picked is held in the article database DB.

The picking assistance device determines whether the article to be picked is a registered article or whether the reliability of the gripping success probability map of the article to be picked is equal to or higher than the second threshold value (step S2001).

When it is determined that the article to be picked is the registered article or the reliability of the gripping success probability map of the article to be picked is equal to or higher than the second threshold value (step S2001: YES), the picking assistance device further determines that the estimation result of the gripping position of the article by the robot 600 based on the gripping information of the article is reliable, and proceeds the processing to step S2002. The picking assistance device estimates the gripping position of the article based on the gripping success probability map of the article to be picked (step S2002). For example, the picking assistance device may estimate, as the gripping position, a position at which the gripping succeeds with the highest probability indicated by the gripping success probability map. Then, the picking assistance device proceeds the processing to step S2004.

When it is determined that the article to be picked is not the registered article and the reliability of the gripping success probability map of the article to be picked is lower than the second threshold value (step S2001: NO), the picking assistance device further determines that the estimation result of the gripping position of the article by the robot 600 based on the gripping information of the article is not reliable, and proceeds the processing to step S2003. The picking assistance device estimates the gripping position of the article to be picked by the learning-based method (step S2003). The picking assistance device may use, for example, a trained machine learning model (a trained model) as the learning-based method. The trained model may be generated to estimate and output the gripping position of the article by the robot 600 in accordance with an input of the information on each of the article to be picked and the robot 600. The information on the article to be picked may be the article information of the article to be picked described above with reference to FIG. 4. The information on the robot 600 may be information on a shape of a portion of the robot 600 that grips an article. The past picking result may be used as training data for generating the trained model. Although a learning algorithm for generating the trained model is not particularly limited, for example, machine learning including a neural network technique such as a convolutional neural network (hereinafter, referred to as a “CNN”) and a deep learning technique may be used.

The picking assistance device transmits a picking instruction based on the gripping position estimated in step S2002 or step S2003 to the robot 600 (step S2004). Then, the robot 600 performs picking of the article to be picked.

The picking assistance device acquires the picking result, that is, the gripping result (step S2005). Then, the picking assistance device ends the processing flow. Step S2005 corresponds to step S1005 of the flowchart illustrated in FIG. 8. After step S2005, the picking assistance device may proceed the processing to step S1006.

As described above, even if the article to be picked is the article under registration, when the reliability of the gripping success probability map is equal to or higher than the predetermined second threshold value, the picking assistance device can determine that the estimation result of the gripping position of the article under registration by the robot 600 based on the gripping information of the article under registration is reliable. Then, the picking assistance device can estimate the gripping position based on the gripping success probability map. In addition, when the reliability of the gripping success probability map of the article to be picked is lower than the predetermined second threshold value, the picking assistance device determines that the estimation result of the gripping position based on the gripping information of the article is not reliable, and can estimate the gripping position by the learning-based method.

The picking assistance device can assign, to the new article, the gripping information of the registered article similar to the new article. Then, the picking assistance device can estimate the gripping position of the new article based on the gripping information. Therefore, the picking assistance device can obtain an estimation result of the gripping position with high reliability even for an article with no or few picking records, such as a new article.

In the present embodiment, it has been described that the gripping of the article by the robot 600 means that the robot 600 holds the article regardless of whether the configuration of the tip portion of the robot 600 is, for example, a suction type or a gripping type by a multi-finger hand. The description has been made without limiting whether the article registered in the article database DB is sucked by the tip portion of the robot 600 or gripped by the hand. However, the article database DB may be created for each gripping method by the robot 600 (for example, a suction type, a gripping type by a multi-finger hand, or the like).

In the present embodiment, an example has been described in which the picking assistance device calculates the similarity for each registered article to the new article, and determines whether the highest similarity among the calculated similarities is equal to or higher than the predetermined first threshold value. In this example, when the highest similarity is equal to or higher than the first threshold value, the picking assistance device assigns the gripping information of the registered article having the highest similarity to the new article, and sets the reliability of the gripping success probability map to the highest similarity. Then, the picking assistance device transmits the instruction to the robot 600 to perform picking at the gripping position estimated based on the gripping information. In addition, in this example, when the highest similarity is lower than the first threshold value, the picking assistance device does not assign the gripping information of any registered article to the new article, and sets the reliability of the gripping success probability map of the new article as the initial value. In this case, the picking assistance device transmits, to the robot 600, an instruction to perform picking at the gripping position estimated by the learning-based method.

However, the present disclosure is not limited to this example, and when the highest similarity among the calculated similarities is equal to or higher than an upper limit value of the predetermined range set for the similarity, the picking assistance device may assign the gripping information of the registered article having the highest similarity to the new article, and may set the reliability of the gripping success probability map to the highest similarity. Then, the picking assistance device may transmit the instruction to the robot 600 to perform picking at the gripping position estimated based on the gripping information. The predetermined range may be freely set by the user, for example. The upper limit value of the predetermined range may be, for example, the predetermined first threshold value in the present embodiment.

When the highest similarity among the calculated similarities is lower than a lower limit value of the predetermined range set for the similarity, the picking assistance device may not assign the gripping information of any registered article to the new article, and may set the reliability of the gripping success probability map of the new article as the initial value. In this case, the picking assistance device may transmit, to the robot 600, the instruction to perform picking at the gripping position estimated by the learning-based method. Hereinafter, the lower limit value of the predetermined range may be referred to as a predetermined fourth threshold value.

When the highest similarity among the calculated similarities is within the predetermined range set for the similarity, the picking assistance device may assign the gripping information of the registered article having the highest similarity to the new article. At this time, the picking assistance device may set the reliability of the gripping success probability map to the highest similarity or the predetermined initial value. The picking assistance device may determine whether the reliability of the gripping success probability map is the highest similarity or the predetermined initial value, for example, based on a user operation. As a result, the user can adjust how much the gripping information of the registered article is reliable. Then, when the reliability of the gripping success probability map of the new article is set to the highest similarity, the picking assistance device may transmit the instruction to the robot 600 to perform picking at the gripping position estimated based on the gripping information. When the reliability of the gripping success probability map of the new article is set to the predetermined initial value, the picking assistance device may transmit the instruction to the robot 600 to perform picking at the gripping position estimated by the learning-based method.

### Summary of Embodiment

The following techniques are disclosed based on the above-described description of the embodiment. Components corresponding to those in the above embodiment are illustrated in parentheses, but the present disclosure is not limited thereto.

### Technique 1

A picking assistance method includes: calculating a similarity of each of one or more types of registered articles (for example, the registered articles 60, 70, and 80) registered in a database (for example, the article database DB), which holds gripping information (for example, the information I5, I6, and I7) including a past gripping result of a picking object by a picking robot (for example, the robot 600), with respect to a new article whose gripping information is not held in the database, when an picking object is the new article (for example, the new article 50); assigning at least a part of the gripping information of the registered article having a highest similarity among the calculated similarities as gripping information of the new article, and temporarily registering the new article in the database, when the highest similarity is equal to or higher than a predetermined first threshold value; and transmitting a picking instruction of the new article to the picking robot based on the gripping information assigned to the new article.

As a result, even when the picking object is, for example, the new article with no prior picking records, the picking assistance method can estimate a gripping position of the picking object based on the information regarding the gripping of an article similar to the picking object. As described above, the picking assistance method can easily realize estimation of the gripping position with high reliability and picking based on the estimated gripping position even for the picking object with no prior picking record.

### Technique 2

The picking assistance method according to Technique 1 further includes: temporarily registering the new article in the database when the highest similarity among the calculated similarities is lower than the predetermined first threshold value; estimating a gripping position of the new article by the picking robot based on article information of the new article; and transmitting the picking instruction of the new article to the picking robot based on the estimated gripping position.

Accordingly, even when there is no registered article similar to the new article, the picking assistance method can estimate the gripping position of the new article using a machine learning model or the like based on the article information such as a shape of the new article, for example. Then, the picking assistance method can cause the picking robot to pick the new article based on the estimated gripping position.

### Technique 3

In the picking assistance method according to Technique 1 or 2, the gripping information further includes a gripping success probability map indicating a gripping success probability of the picking robot at a predetermined gripping position of the picking object and a reliability of the gripping success probability map, and the picking assistance method further includes: setting a value of the highest similarity as the reliability of the gripping success probability map of the new article when the highest similarity among the calculated similarities is equal to or higher than the predetermined first threshold value; and setting a predetermined initial value smaller than the predetermined first threshold value as the reliability of the gripping success probability map of the new article when the highest similarity is lower than the predetermined first threshold value.

Accordingly, in the picking assistance method, when there is a registered article similar to the new article, the similarity of the registered article to the new article can be set as the reliability of the gripping success probability map among the gripping information of the new article. In addition, in the picking assistance method, when there is no registered article similar to the new article, the predetermined initial value can be set as the reliability of the gripping success probability map of the new article.

### Technique 4

The picking assistance method according to Technique 3 further includes: estimating the gripping position of the new article by the picking robot based on the gripping success probability map of the new article, when the reliability of the gripping success probability map of the new article is equal to or higher than a predetermined second threshold value; estimating the gripping position of the new article by the picking robot based on article information of the new article, when the reliability of the gripping success probability map of the new article is lower than the predetermined second threshold value; and transmitting the picking instruction of the new article to the picking robot based on the estimated gripping position.

Accordingly, in the picking assistance method, when the reliability of the gripping success probability map of the new article is equal to or higher than the predetermined second threshold value, it is possible to transmit the instruction to the picking robot to pick at the gripping position estimated based on the gripping success probability map. In addition, in the picking assistance method, when the reliability of the gripping success probability map of the new article is lower than the predetermined second threshold value, for example, the gripping position of the new article can be estimated using the machine learning model or the like based on the article information such as the shape of the new article. Then, the picking assistance method can cause the picking robot to pick the new article based on the estimated gripping position.

### Technique 5

The picking assistance method according to technique 3 or 4 further includes: determining whether the gripping success probability of the new article by the picking robot is equal to or higher than a predetermined third threshold value based on a plurality of gripping results of the new article by the picking robot based on the picking instruction; and updating the reliability of the gripping success probability map of the new article so as to increase by a predetermined value, when it is determined that the gripping success probability is equal to or higher than the predetermined third threshold value.

Accordingly, the picking assistance method can update the reliability of the gripping success probability map of the new article based on the gripping success probability of the new article.

### Technique 6

The picking assistance method according to technique 5 further includes: registering, in the database, the temporarily registered new article for which the reliability of the gripping success probability map is equal to or higher than a predetermined specified value as a registered article.

Accordingly, in the picking assistance method, when the reliability of the gripping success probability map of the new article is equal to or higher than the predetermined specified value, the new article can be registered in the database as the registered article.

### Technique 7

The picking assistance method according to technique 2 or 4 further includes: estimating the gripping position of the new article by inputting the article information of the new article and information of the picking robot to a trained model that estimates the gripping position of the picking object by the picking robot in accordance with an input of information on each of the picking object and the picking robot.

Accordingly, the picking assistance method can estimate the gripping position of the new article using the trained model.

### Technique 8

The picking assistance method according to any one of techniques 1 to 7 further includes: calculating the similarity of the registered article to the new article based on a feature of a captured image of each of the new article and the registered article, a physical parameter indicating a size and a weight, and a text included in the captured image.

Accordingly, the picking assistance method can calculate the similarity of the registered article to the new article based on the feature of the captured image of each of the new article and the registered article, the physical parameter, and the text information included in the captured image.

### Technique 9

A picking assistance device (for example, the warehouse control system 300 and the information processing device 10) includes a processing device (for example, the processing device 11) and is a picking assistance device configured to perform data communication with each of a picking robot that picks a picking object and a database that holds gripping information including a past gripping result of the picking object by the picking robot, and the processing device is configured to: calculate a similarity of each of one or more types of registered articles registered in the database with respect to a new article whose gripping information is not held in the database, when the picking object is the new article, assign at least a part of the gripping information of the registered article having a highest similarity among the calculated similarities as gripping information of the new article, and temporarily register the new article in the database, when the highest similarity is equal to or higher than a predetermined first threshold value; and transmit a picking instruction of the new article to the picking robot based on the gripping information assigned to the new article.

Accordingly, the picking assistance device can obtain the same effects as those of technique 1.

The functions of the embodiment described above can also be implemented by processing of supplying programs and applications for implementing the functions of the embodiment described above to a system or device using a network, a storage medium, or the like, and having one or more processors in a computer of that system or device read and execute the programs.

The functions of the embodiment described above may be implemented by a circuit (for example, an application specific integrated circuit (hereinafter, referred to as an “ASIC”) or an FPGA) that implements one or more functions.

Although the embodiment has been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the embodiment described above may be combined freely within a range without departing from the gist of the disclosure.

What is claimed is:

1. A picking assistance method comprising:
calculating a similarity of each of one or more types of registered articles registered in a database, which holds gripping information including a past gripping result of a picking object by a picking robot, with respect to a new article whose gripping information is not held in the database, when an picking object is the new article;
assigning at least a part of the gripping information of the registered article having a highest similarity among the calculated similarities as gripping information of the new article, and temporarily registering the new article in the database, when the highest similarity is equal to or higher than a predetermined first threshold value; and
transmitting a picking instruction of the new article to the picking robot based on the gripping information assigned to the new article.

2. The picking assistance method according to claim 1, further comprising:
temporarily registering the new article in the database when the highest similarity among the calculated similarities is lower than the predetermined first threshold value;
estimating a gripping position of the new article by the picking robot based on article information of the new article; and
transmitting the picking instruction of the new article to the picking robot based on the estimated gripping position.

3. The picking assistance method according to claim 1, wherein
the gripping information further includes: a gripping success probability map indicating a gripping success probability of the picking robot at a predetermined gripping position of the picking object; and a reliability of the gripping success probability map, and
the picking assistance method further comprises:
setting a value of the highest similarity as the reliability of the gripping success probability map of the new article when the highest similarity among the calculated similarities is equal to or higher than the predetermined first threshold value; and
setting a predetermined initial value smaller than the predetermined first threshold value as the reliability of the gripping success probability map of the new article when the highest similarity is lower than the predetermined first threshold value.

4. The picking assistance method according to claim 3, further comprising:
estimating the gripping position of the new article by the picking robot based on the gripping success probability map of the new article, when the reliability of the gripping success probability map of the new article is equal to or higher than a predetermined second threshold value;
estimating the gripping position of the new article by the picking robot based on article information of the new article, when the reliability of the gripping success probability map of the new article is lower than the predetermined second threshold value; and
transmitting the picking instruction of the new article to the picking robot based on the estimated gripping position.

5. The picking assistance method according to claim 4, further comprising:
determining whether the gripping success probability of the new article by the picking robot is equal to or higher than a predetermined third threshold value based on a plurality of gripping results of the new article by the picking robot based on the picking instruction; and
updating the reliability of the gripping success probability map of the new article so as to increase by a predetermined value, when being determined that the gripping success probability is equal to or higher than the predetermined third threshold value.

6. The picking assistance method according to claim 5, further comprising:
registering, in the database, the temporarily registered new article for which the reliability of the gripping success probability map is equal to or higher than a predetermined specified value as a registered article.

7. The picking assistance method according to claim 2, further comprising:
estimating the gripping position of the new article by inputting the article information of the new article and information of the picking robot to a trained model that estimates the gripping position of the picking object by the picking robot in accordance with an input of information on each of the picking object and the picking robot.

8. The picking assistance method according to claim 1, further comprising:
calculating the similarity of the registered article to the new article based on a feature of a captured image of each of the new article and the registered article, a physical parameter indicating a size and a weight, and a text included in the captured image.

9. A picking assistance device comprising:
a processing device, wherein
the picking assistance device is configured to perform data communication with each of a picking robot that picks a picking object and a database that holds gripping information including a past gripping result of the picking object by the picking robot, and
the processing device is configured to:
calculate a similarity of each of one or more types of registered articles registered in the database with respect to a new article whose gripping information is not held in the database, when the picking object is the new article;
assign at least a part of the gripping information of the registered article having a highest similarity among the calculated similarities as gripping information of the new article, and temporarily register the new article in the database, when the highest similarity is equal to or higher than a predetermined first threshold value; and
transmit a picking instruction of the new article to the picking robot based on the gripping information assigned to the new article.
